(19) United States
(12) Patent Application Publication
(10) Pub. No.: US 2019/0262840 A1
(43) Pub. Date: Aug. 29, 2019

(54) IMPACT REACTOR FOR COMMINUTING COMPOSITE MATERIAL AND METHOD FOR COMMINUTING COMPOSITE MATERIAL

(71) Applicant: SCHÄFER ELEKTROTECHNIK U. SONDERMASCHINEN GMBH, Rüssingen (DE)

(72) Inventor: Ralf SCHÄFER, Rüssingen (DE)

(21) Appl. No.: 16/344,906

(22) PCT Filed: Oct. 26, 2017
(86) PCT No.: PCT/EP2017/077513

§ 371 Date: Apr. 25, 2019

(30) Foreign Application Priority Data
Oct. 26, 2016 (DE) 10 2016 120 467.6

(51) Int. Cl. B02C 23/36; B02C 13/14

(52) U.S. Cl. CPC B02C 23/36; B02C 13/14

(57) ABSTRACT

Impact reactor (1) for comminuting composite materials, comprising a cylindrical casing (2), in which a rotor (3) is arranged, and an introducing opening (9) for introducing the composite materials and an extraction opening (8) for discharging the comminuted composite materials, wherein at least one further introducing opening (10) for a cooling medium is provided.

The invention relates to an impact reactor for comminuting composite materials, comprising a cylindrical casing, in which a rotor is arranged, and an introducing opening for introducing the composite materials and an extraction opening for discharging the comminuted composite materials.

Impact reactors are used in order to comminute objects which are composed of different materials, in such a way as to allow the separation of substances. As a result, the objects are comminuted and separated into individual components by impact stress with high momentum transfer by means of rotating impact elements.

EP 0 859 693 B1 discloses an impact reactor comprising a cylindrical main body, in which a rotor driven by a drive motor is arranged. The rotor is formed from wear-resistant steel and has replaceable impact elements on its propeller-shaped or blade-shaped ends.

In the circumferential area of the impact reactor, extraction openings are arranged. These can be covered with slotted or perforated plates so as to be able to achieve a differentiated discharge of comminuted particles in a desired particle size.

When comminuting synthetic material-containing composite materials, there is the problem that the synthetic material heats up due to the large amount of energy being introduced as a result of the high mechanical stress, and thus high-quality re-use of the synthetic material is often no longer possible. Drinks packaging often includes at least one packaging portion of polyethylene terephthalate (PET). High-quality re-use of this material is possible and it can be re-processed for example to form textile fibers. However, in that case it is essential that PET-containing materials are not heated during comminuting to the extent that the material properties are changed disadvantageously.

The object of the invention is to provide an impact reactor for comminuting composite materials which permits protective comminuting of temperature-sensitive materials.

This object is achieved by the features of claim 1. The dependent claims refer to advantageous embodiments.

The inventive impact reactor for comminuting composite materials comprises a cylindrical casing, in which a rotor is arranged, and an introducing opening for introducing the composite materials and an extraction opening for discharging the comminuted composite materials, wherein at least one further introducing opening for a cooling medium is provided.

In addition to the composite materials, a cooling medium is introduced into the impact reactor during the comminuting process. As the rotor is applying mechanical stress, the composite materials and cooling medium are rapidly and thoroughly mixed together, and so—despite the high mechanical stress and a high momentum transfer between the rotor and composite materials or between the casing and composite materials—the composite materials do not become overheated.

The rotor can be provided with impact elements which are arranged on the free ends of the rotor blades. The rotor can comprise bar-shaped rotor blades or also alternatively chains, cables, fin-shaped rotor blades or impellers.

Preferably, the cooling medium includes water. Water is particularly cost-effective and simple to use. Furthermore, it has surprisingly been found that in particular PET-containing composite materials, such as e.g. drinks packaging, can be comminuted in an impact reactor in a particularly efficient and protective manner when the process is carried out together with water. This is due to the fact that the water introduced into the impact reactor rapidly mixes with the composite materials. The water thereby attenuates the momentum transfer of the rotor to the composite materials but at the same time transfers the received momentum to the composite materials. This effects protective separation of the composite materials. By virtue of the fact that water has a very high energy absorption capacity, heating of the composite materials can be effectively avoided. In this respect, water permits protective comminuting of composite materials in an impact reactor and at the same time prevents overheating of the composite materials.

A further advantage of water is that possible water-soluble impurities and residues can be removed from the composite materials. This is particularly advantageous in connection with the comminuting of drinks packaging. Residues of drinks and the like are usually found in drinks packaging. The result of the comminuting are composite materials which are comminuted, i.e. separated into individual components, and cleaned.

The cooling medium can include an additive. Additives are in particular those substances which improve cleaning and separation of substances of the composite materials. Such additives are e.g. surfactant-containing or alcohol-containing cleaning agents which partially dissolve drinks residues and the like. Other possible additives include solvents which e.g. detach adhered labels or adhesive residues from the composite materials.

It is also possible to use liquid nitrogen or dry ice alone or together with water as the cooling medium. Both significantly cool the composite materials and prevent overheating of the material during comminuting. Furthermore, the intense cooling produces embrittlement of the composite materials which can assist the separation.

A classifying device can be assigned to the extraction opening. This is particularly advantageous when the comminuted composite materials are discharged from the impact reactor continuously. This is e.g. the case when the extraction opening of the impact reactor is opened at least during the comminuting process. In principle, batch-wise operation is also possible. This is particularly the case when the dwell time of the composite materials in the impact reactor is very short.

When film-containing composite materials are being comminuted, it is advantageous if the classifying device is formed as an air separator. This permits effective separation of the film-like components from the material removed from the impact reactor.

Preferably, the impact reactor comprises a cover which, together with the casing, delimits an impact reactor chamber. The further introducing opening can be assigned with the casing and/or to the cover. In this respect, it is particularly possible that a water connection is integrated in the casing and/or cover. The water connection can be formed in such a way that a jet of water is directed towards the rotor. The mechanical stress of the composite materials is highest in the region of the rotor and thus particularly effective cooling is possible when the jet of water is directed directly towards the rotor.

In the inventive method for comminuting composite materials in an impact reactor, composite materials are introduced into an impact reactor chamber via an introducing opening. The composite materials are comminuted in the impact reactor chamber under the effect of the rotor and are discharged from the impact reactor chamber via an extraction opening. In accordance with the invention, a cooling medium is introduced into the impact reactor chamber with the composite materials. The cooling medium is preferably introduced into the impact reactor chamber at the same time as the composite materials.

The cooling medium can be liquid nitrogen, dry ice or a comparable cooling medium. The cooling medium is preferably water which is introduced into the impact reactor chamber via an introducing opening. The cooling medium can further include an additive.

The comminuted composite materials can be continuously extracted from the impact reactor chamber. Alternatively, the comminuted composite materials can be extracted from the impact reactor chamber in a batch-wise manner.

In particular in the case of drinks packaging consisting of synthetic material, e.g. PET, the composite materials are those with a comparatively low specific weight and a comparatively low strength. By use of the inventive method, according to which—in addition to the composite materials—a cooling medium is also introduced into the impact reactor chamber, it can be prevented that the composite materials are heated up, which would prevent them from being used again. Due to the low specific weight and the comparatively low strength, only a short dwell time of the composite materials in the impact reactor chamber is required. The composite materials can thus be extracted from the impact reactor chamber continuously.

A dwell time of up to 10 seconds is sufficient for comminuting synthetic material-containing composite materials. It is frequently desirable that the composite materials are merely separated into their individual components and are not further comminuted. It is thereby possible that the dwell time is merely fractions of a second. This can be the case in particular when the rotor comprises a plurality of rotor blades which are arranged one above the other and which can be arranged offset from one another on the same shaft. With this arrangement, a type of labyrinth is formed which effects rapid comminuting.

By use of the inventive method, in particular the use of water as the cooling medium and the short dwell time of the composite materials of a few seconds in the impact reactor chamber, it is ensured that the composite materials are merely separated into their individual components. Classification can take place after the extraction of the comminuted composite materials. The classification means can be formed e.g. in the form of an air separator or in the form of a screen. For film-containing composite materials, the use of an air separator has proved to be advantageous and very effective.

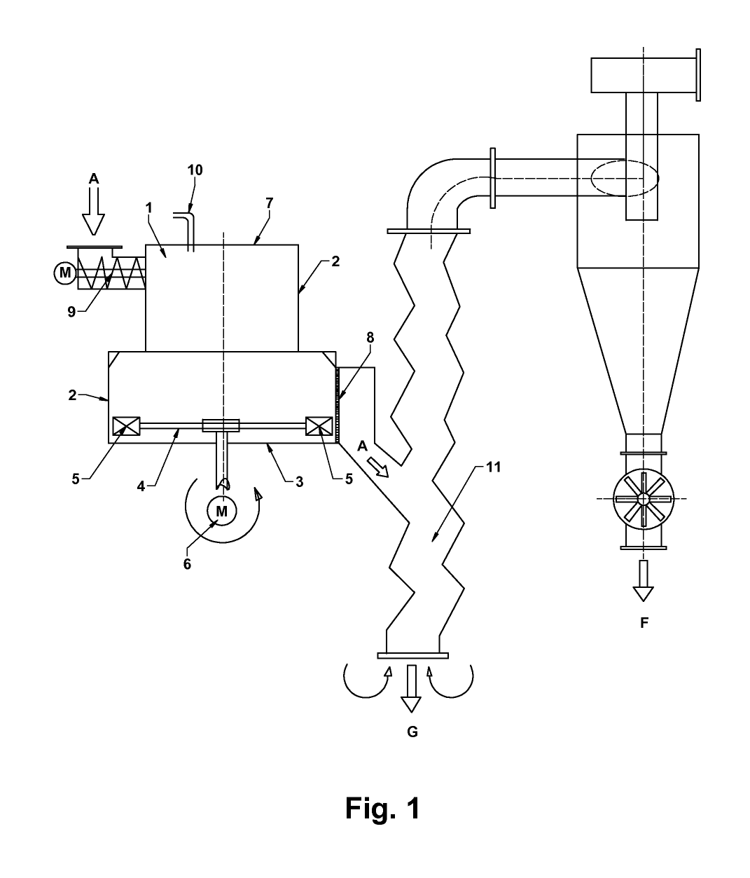

FIG. 1 schematically shows an embodiment of the inventive impact reactor.

FIG. 1 shows an impact reactor 1 or an impact reactor arrangement for comminuting composite materials. The impact reactor 1 comprises a cylindrical casing 2 consisting of metallic material. A rotor 3 which is provided with impact elements 5 is arranged in the interior of the casing 2 in the bottom area. The rotor 3 is operatively connected to an electric motor 6 which is arranged outside the casing 2. The shaft connecting the rotor 3 to the electric motor 6 extends in the axial direction of the cylindrical casing 2. The rotor 3 is provided with blades 4 which protrude radially from the shaft. Impact elements 5 are arranged at the ends of the free blades 4. The impact elements 5 are interchangeably fastened to the blades 4.

The impact reactor 1 is closed, at the end face facing away from the rotor, by means of a cover 7. The casing 2 comprising an introducing opening 9 for introducing the composite materials. In the region of the rotor 3, the casing 2 further comprises an extraction opening 8 for discharging the comminuted composite materials. A further introducing opening 10 for a cooling medium is integrated into the cover 7. In the present embodiment, the further introducing opening 10 is formed as a pipe connection, through which water can be led into the impact reactor chamber delimited by the casing 2 and the cover 7.

A classifying device 11 in the form of an air separator is assigned to the extraction opening 8.

The composite materials are introduced into the impact reactor chamber via the introducing opening 9 for comminuting. Furthermore, a cooling medium is introduced into the impact reactor via the further introducing opening 10. The composite materials are comminuted under the effect of the rotor 3 provided with the impact elements 5 and under the effect of the cooling medium, and are ultimately discharged from the impact reactor chamber via the extraction opening 8. Classification by means of an air separator takes place after the extraction of the comminuted composite materials. In the present embodiment, the comminuted composite materials are extracted from the impact reactor chamber continuously. However, the device is also suitable for batch-wise operation.

What is claimed is:

1. An impact reactor for comminuting composite materials, comprising a cylindrical casing in which a rotor is arranged, and an introducing opening for introducing the composite materials and an extraction opening for discharging the comminuted composite materials, characterized in that at least one further introducing opening for a cooling medium is provided.

2. The impact reactor according to claim 1, wherein the cooling medium includes water.

3. The impact reactor according to claim 2, wherein the cooling medium includes an additive.

4. The impact reactor according to claim 1, wherein the cooling medium includes dry ice and/or liquid nitrogen.

5. The impact reactor according to claim 1, wherein a classifying device is assigned to the extraction opening.

6. The impact reactor according to claim 1, wherein the impact reactor comprises a cover which, together with the casing, delimits an impact reactor chamber.

7. The impact reactor according to claim 6, wherein the further introducing opening is assigned to the casing and/or to the cover.

8. A method for comminuting composite materials in an impact reactor, in which composite materials are introduced into an impact reactor chamber via an introducing opening, are comminuted in the impact reactor chamber under the effect of the rotor and are discharged from the impact reactor chamber via an extraction opening, characterized in that a cooling medium is introduced into the impact reactor chamber together with the composite materials.

9. The method according to claim 8, wherein the comminuted composite materials are extracted from the impact reactor chamber continuously.

10. The method according to claim 8, wherein classification takes place after extraction of the comminuted composite materials.

11. The impact reactor according to claim 2, wherein the cooling medium includes dry ice and/or liquid nitrogen.

12. The impact reactor according to claim 3, wherein the cooling medium includes dry ice and/or liquid nitrogen.

13. The impact reactor according to claim 2, wherein a classifying device is assigned to the extraction opening.

14. The impact reactor according to claim 3, wherein a classifying device is assigned to the extraction opening.

15. The impact reactor according to claim 4, wherein a classifying device is assigned to the extraction opening.

16. The impact reactor according to claim 2, wherein the impact reactor comprises a cover which, together with the casing, delimits an impact reactor chamber.

17. The impact reactor according to claim 3, wherein the impact reactor comprises a cover which, together with the casing, delimits an impact reactor chamber.

18. The impact reactor according to claim 4, wherein the impact reactor comprises a cover which, together with the casing, delimits an impact reactor chamber.

19. The impact reactor according to claim 5, wherein the impact reactor comprises a cover which, together with the casing, delimits an impact reactor chamber.

20. The method according to claim 9, wherein classification takes place after extraction of the comminuted composite materials.
